(19) United States
(12) Patent Application Publication
(10) Pub. No.: US 2008/0034290 A1
(43) Pub. Date: Feb. 7, 2008

(54) System for foreign and remote architectural and engineering services for U.S. construction projects

(76) Inventor: Bernard Woodard, Cottage Grove, OR (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/485,616

(22) Filed: Jul. 12, 2006

(51) Int. Cl. G06F 3/00

(52) U.S. Cl. 715/700

(57) ABSTRACT

A method of generating blueprints and engineering drawings comprising employing a central manager to obtain a list of project plans and specifications; identifying a plurality of projects for which blueprints or engineering drawings must be prepared; distributing the project a plurality of remote quantification architecture and engineering processing centers to create blueprints on the projects located in the United States.

### CLAIM OF PRIORITY

The application claims priority to U.S. application Ser. No. 11/036,286 filed Jan. 13, 2005, and also claims priority to U.S. application Ser. No. 11/332,855 filed Jan. 13, 2006, both of which are incorporated by reference as if set forth in full.

### FIELD OF THE INVENTION

The present invention is directed to the field of construction. In particular, the present invention is directed to a system and method whereby blueprints and engineering drawings can be generated remotely at remote, lower priced drafting centers.

### BACKGROUND OF THE INVENTION

The creation of blueprints and engineering drawings are an architectural component of the construction process. There is an ongoing need for a system and method to create engineering and architectural drawings and one which can be created by lower priced personnel. Typically, such drawings are made and prepared by expensive domestic drafting personnel, architects or engineers.

There have been a number of patents directed to the field of outsourcing. U.S. Pat. No. 6,957,341 discloses a method and system for secure computational outsourcing and disguise. According to an embodiment, a first set of actual arguments and a second set of actual arguments for an outsourced computation are determined. A first group of disguised arguments corresponding to the first set of actual arguments is prepared with a first computer. A second group of disguised arguments corresponding to the second set of actual arguments is prepared with a second computer. The first and second groups of disguised arguments are output from the first and second computers, respectively, for performance of the outsourced computation. A third computer performs the outsourced computation and returns a disguised result to the first and/or second computers. The first and/or second computers then unveil the actual result from the disguised result. While there have been a number of systems, none have adequately addressed the needs of architects and engineers to provide blue prints and drawings at a reasonable rate.

U.S. Pat. No. 6,301,574 discloses an apparatus, method and data structure for communicating business information, including outsourcing information. Contractor provides information regarding their products and services into the system. Outsourcing companies search a database containing contractor information to determine which contractors meet a particular search criteria. Selected contractors receive project information and, optionally, a bid template. Bid information is supplied to the database operator. The operator prepares a table of bid information that is sent to the outsourcing companies for review. Evaluation information relating to contractors and outsourcing companies is obtained from both outsourcing companies and contractors and stored on a database. The evaluation information is provided to outsourcing companies and contractors as part of the bid and project information It is an object of the present invention to provide a system in which architectural and engineering drawings can be prepared for specific projects being built in the United States.

U.S. Pat. No. 6,941,463 discloses technique includes the determination of a set of arguments for an outsourced computation and preparing a group of disguised arguments corresponding to the set of arguments with a first computer. The first computer outputs the disguised arguments to a second computer. The second computer performs the outsourced computation with the disguised arguments to determine a corresponding disguised result. The second computer returns the disguised result to the first computer. The first computer recovers an actual answer from the disguised result. Before outsourcing, the first computer can classify the outsourced computation into one of a number of computation types and select one or more of a number of disguising operations based this classification.

U.S. Pat. No. 6,895,382 discloses an invention relates to a method for implementing an off shore/off site activity in an organization, with most optimal skills transfer process. The said process includes the steps of assessing the suitability of outsourcing and whether the activity should be carried out on-site, locally or remotely, based on pre-determined parameters and decision ratios; planning the process including the minimum groundwork required before the actual process can begin; identifying the various milestones in the process and the deliverables in each milestones; monitoring the progress of the migration process and the ways and means to take corrective action; and evaluating the results of the development.

Patent 20010051913 discloses A method and system for facilitating the outsourcing of information technology of projects and services is provided. The method and system can be implemented to enable buyers and IT providers to confer and agree in a very efficient, neutral and intelligent manner. The information technology projects and services can range from the simple and not urgent, to the complex and time critical. An exemplary outsourcing method and system can comprise a start module, a registration module, a request for proposal (RFP) module, a matching module, a bidding and discussion module, and a selection module configured for the planning, outsourcing, and procuring of information technology projects and services. In addition, a system and method for outsourcing IT projects arid services can also include a project administration method and system for delivering and/or managing the IT projects and services. In accordance with an exemplary embodiment, the project administration method and system can be configured to enable the buyer and the provider to oversee the delivery of the IT project, such as by using a browser-based application, to provide a secure workspace where project teams can suitably collaborate, conduct online conversations, track project milestones, monitor service levels, resolve issues, solicit feedback and/or authorize payment. Further, the method and system can be accomplished by providing automated processes and systems, through online and/or packaged software, implemented at the host and client systems. The automated processes and systems can comprise extensive knowledge base, rule-based and state of the art database driven; self-learning business logic based on an end-to-end IT outsourcing process. In addition, security features can be suitably implemented to provide protection to the to data and information for buyers and prospective providers.

Patent 20030069777 discloses an integrated system for providing remote outsourcing of services includes at least one local service center located relatively near to users and being operative to communicate with the users via communications media, at least one remote service center located relatively far from the users and communicating with service providers who are located closer to the remote service center than to at least most users, and an at least partially dedicated high speed communications link interconnecting the local and remote service centers, and wherein the service providers provide at least secretarial services for the users and communicating their work product via the remote service center, the high speed communications link and the local service center to the users.

Patent Application 20040193533 discloses a project bidding transaction management system in accordance with a preferred embodiment of the present invention includes a database server (1) for storing data used or generated in implementing the project bidding transaction management system, and an application server (2) for managing project bidding transactions. The application server includes: a basic data maintenance module (20) for receiving requirements of outsourcing projects, and generating specifications for the outsourcing projects; a bidder selection module (21) for selecting a plurality of suitable bidders from a list of companies wishing to bid on an outsourcing project; a price negotiation management module (22) for performing price negotiations with bidders, and generating price negotiation records; and a bid comparison module (23) for determining a winning bidder as a contractor for each outsourcing project, and generating bid results. A project bidding transaction management method is also disclosed in the present invention.

While there have been a number of systems for controlling bids and for outsourcing work in a variety of areas, none have adequately addressed the needs of architects and engineers to provide blue prints and drawings at a reasonable rate.

It is an object of the present invention to provide a system in which architectural and engineering drawings can be prepared for specific projects being built in the United States.

It is still a further object of the present invention, to provide a system in which a foreign or remote service can prepare blue prints or engineering drawings for a single or plurality of projects being built and/or remodeled, at any location.

These and other objects of the invention will become apparent from the detailed description and claims.

### SUMMARY OF THE INVENTION

This invention is a system for outsourcing engineering and architectural drawings. A method of generating blueprints and engineering drawings comprising: employing a central manager to obtain a list of project plans and specifications and to identify a plurality of projects for which blueprints or engineering drawings must be prepared; distributing the project a plurality of remote processing centers to prepare blueprints on the projects.

A further embodiment of the present invention includes a plurality of remote centers in a plurality of remote countries.

Yet another embodiment of the present invention includes a method where each of said remote quantification centers in a particular geographic region or construction category.

### BRIEF DESCRIPTION OF THE FIGURES

FIG. 1 is a block diagram of the operation of the system in accordance with the present invention.

FIG. 2 is a block diagram of a regional system in accordance with the invention.

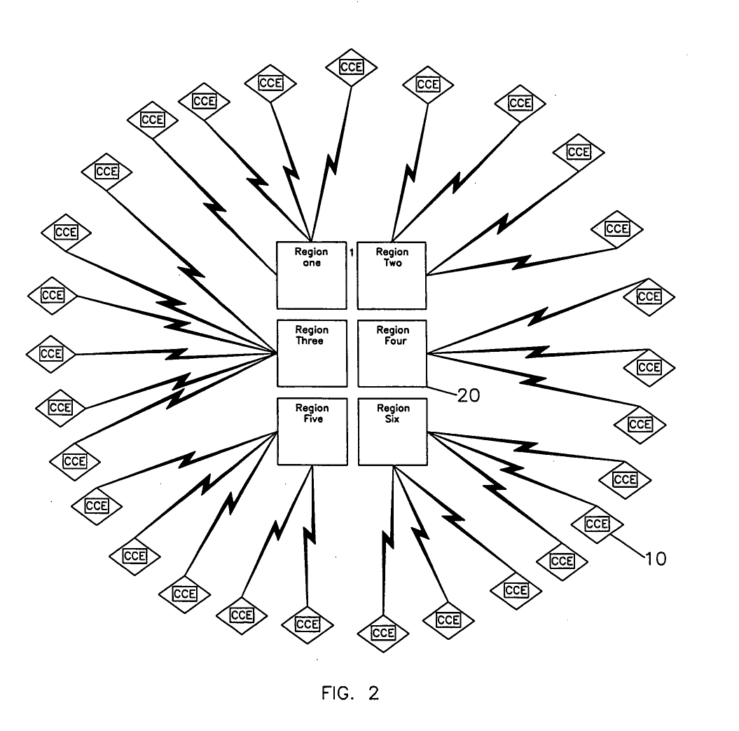

FIG. 3 is an enhanced block diagram of the invention.

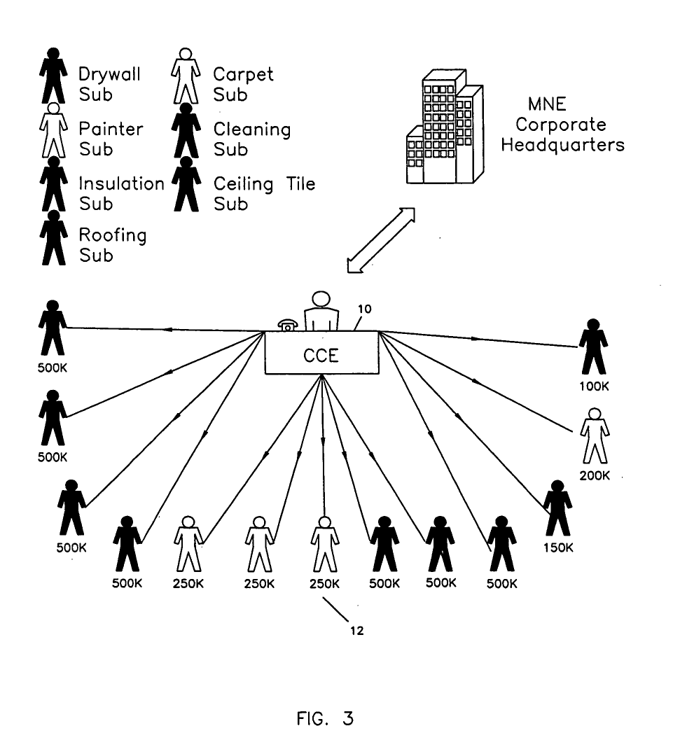

FIG. 4 illustrates the generation using the present invention.

FIG. 5 is a further flow chart in accordance with the invention which illustrates the material supplier approval process.

### DETAILED DESCRIPTION OF THE INVENTION

The present invention is described with reference to the enclosed Figures, wherein the same numbers are used where applicable. The present invention is a system directed to controlling the costs of construction engineering drawings and blueprints for projects being built in the United States. In a broad embodiment, an entity desires to build a hospital, school, bridge, home, apartment, etc. or other type of construction project. The owner then chooses an architect and/or engineer to draw all of the blueprints for any structures and put together the specifications as to how the buildings will be built.

Most American architects/engineers generally have a state certification which permits them to sign final drawings and specifications. The architect/engineer uses local or intra architects, engineers and draftsmen to prepare the plans and specifications which are normally very expensive. The State Certified lead Architect/Engineer then signs the plans and the project moves forward to completion.

The invention system herein allows for the owner of a planned construction project in the United States, or a state certified architect and/or engineer to use foreign or remote architects, engineers and draftsmen who can complete these projects at a lower rate.

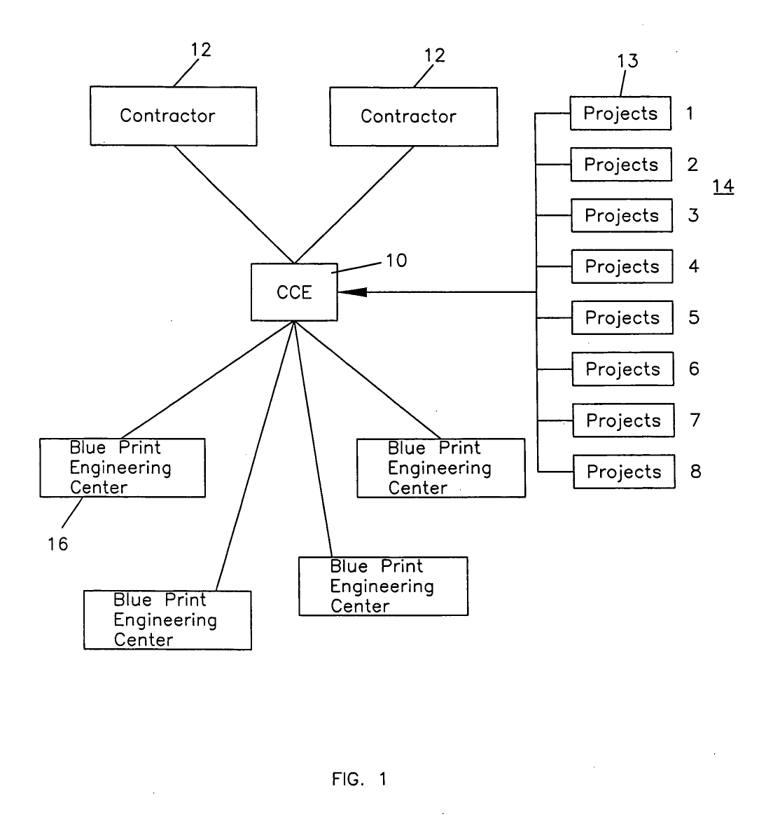

As shown in FIG. 1, the remote architects, engineers and/or Draftsmen would draw all or part of the plans and organize the specifications from a foreign or remote location. After a specified part and/or all the work was completed, they would send the package back to the United States electronically or hard paper final form for final any required final approval, or certification from the locally certified architect and/or engineer. This process would save the owners, or locally licensed Architect and/or Engineer of a potential construction project being built in the United States substantial amounts of money.

The owner would basically hire the more expensive and locally licensed Architect and/or Engineer to create project drawings and specification organization and finally certifying the documents as required.

The invention permits a Foreign Processing Center more Architects, Engineers or Draftsmen to design and produce blueprints for construction projects being built in the United States and send them to the United States by mail and/or electronically for any required final certification;

This method will allow a Foreign organization with 1 or more Architects, Engineers or Draftsmen to design and produce any part of the blueprints for construction projects being built in the United States and send them to the United States by mail and/or electronically for any required final certification.

The Foreign Center with Architects, Engineers or Draftsmen will design and produce blueprints, or any part thereof, for construction projects being built in the United States and send then to the United States by mail and/or electronically for any required final certification. This invention allows a remote Processing Center in a separate State in the United States than where the work is being built to perform.

This method potentially further regulates the local Architect/Engineer to a final approval of the plans and specifications status, as well as overseeing the construction of a project. The invention comprises of a master contractor who contracts or projects out for bid 13 within a region or area. The manager 10 will obtain the requirement for the particular bidding projects such as a hospital building or office. Many of these are available on publicly available websites. Specifically, this individual will receive information on each job.

Based upon the needs of the contractor, specific project plans and specifications will then be sent electronically, or by other means, to a center 16 is preferably remote and it may be located in a foreign country. Each center 16 will preferably be restricted to a particular region or specialty. This will permit the centers 16 to develop expertise in areas of specialty (e.g., commercial, residential) or specific region of the country. The blue print processing center will use high speed internet and utilize specialized software to create blueprints or engineering drawings.

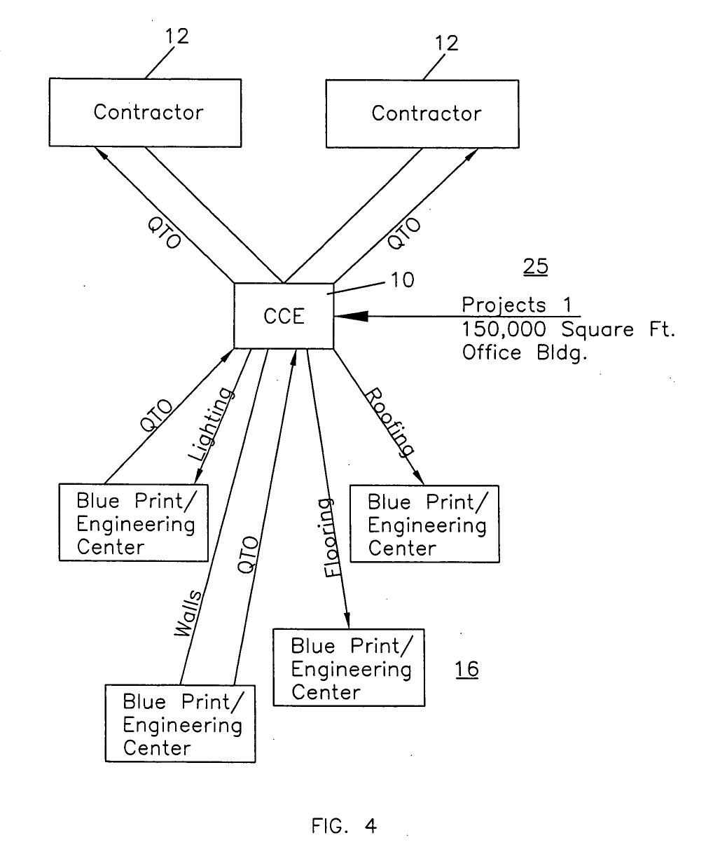

The present invention thus provides a system to assist special trade contractors in procuring contracts from general contractors, builders, owners, government, etc. Referring to FIG. 4, after blueprints or engineering drawings are generated, they are forwarded to a central center. If the drawings are accepted, the center receives financial remuneration.

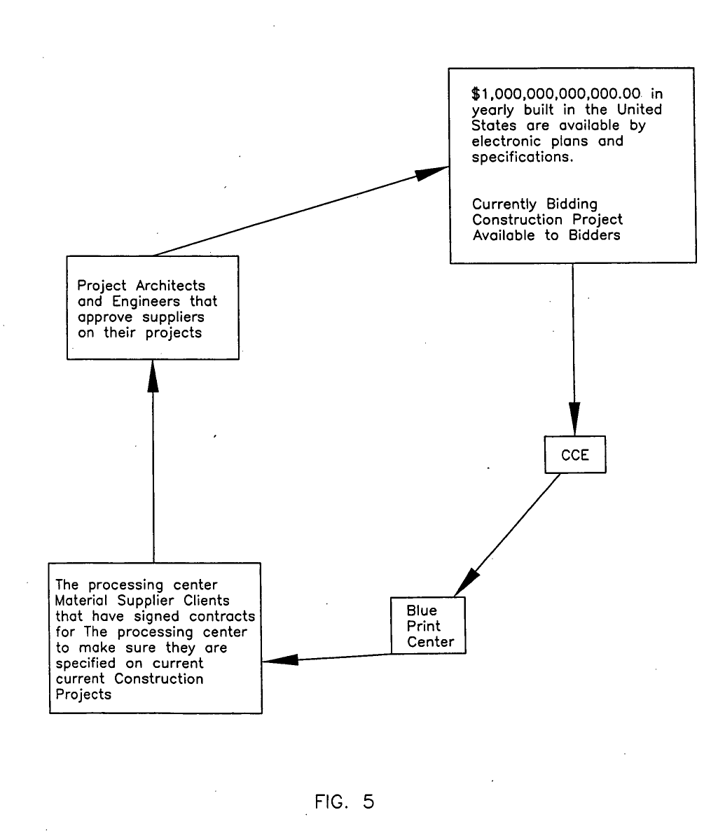

Referring to FIGS. 4 and 5, the over all operation of the invention is shown. As shown in FIG. 5, a huge volume of contracts are made available. These are acquired by the 10 who forward them to the center. In FIG. 5, the contracts are sent directly to the foreign processing center where blueprints are generated and then on to the general contractors to procure bids.

In a blueprint generation center is a foreign based center whereby at least one person completes blue prints or engineering drawings for any type of construction being built in the United States (US). The system then sends the drawings or blue prints electronically via internet, fax, and/or any new electronic technology to the center 10 the US; or directly to the specialty contractor 12 in the United States for finalizing a construction bid on projects located in the U S.

In a third embodiment, the system uses a domestic blueprint center whereby at least one person completes a blueprint for any type of construction being built in the United States (US). The system then sends those blueprints electronically via internet, fax, and/or any technology to the center in the US; or directly to a contractor in the United States.

Finally, the system may use a center whereby at least one person analyzes the plans and specifications for specified approved suppliers of any type of construction being built in the US.

The invention also envisions the process of supplying blueprints to clients based solely upon receiving a fee from our clients based upon success of their receiving a contract. The invention also embodies a process of supplying blueprints to a plurality of different types of specialty trade contractors in a given area; and the process of having a center or any bidding specialist in a given area assist a plurality of different types of specialty trade contractors submit bids to owners, general contractors, etc.

The present invention has been described with reference to the enclosed preferred embodiment. It is to be appreciated that the true nature and scope of the invention is to be determined with reference to the attached claims.

1. A method of generating blueprints and engineering drawings comprising:
employing a central manager to obtain a list of project plans and specifications and to identify a plurality of projects for which blueprints or engineering drawings must be prepared;
distributing the project a plurality of remote processing centers to prepare blueprints on the projects.

2. The method of claim 1 wherein the plurality of centers are in a plurality of remote countries.

3. The method of claim 1 where each of said blue print generating centers in a particular geographic region or construction category.

4. A method for remotely producing blue prints for a plurality of projectors:
aggregating a plurality of construction project plans and specifications; and
distributing the construction plans and specifications to a remote center or a plurality of remote centers who generate blue prints or engineering drawings.
